(19) United States
(12) Patent Application Publication
(10) Pub. No.: US 2013/0266670 A1
(43) Pub. Date: Oct. 10, 2013

(54) Fungicidal Bactericidal and/or Antioxidant Treatment of Foodstuffs Via Application of Formulations Comprising an Essential Oil and a Dialkylene Glycol

(71) Applicant: Alberto Sardo, Chateaurenard (FR)

(72) Inventor: Alberto Sardo, Chateaurenard (FR)

(73) Assignee: XEDA INTERNATIONAL, Saint Andiol (FR)

(21) Appl. No.: 13/821,838

(22) PCT Filed: Sep. 7, 2011
(86) PCT No.: PCT/FR2011/052047

§ 371 Date: Jun. 25, 2013

(30) Foreign Application Priority Data
Sep. 9, 2010 (FR) 10 57158

(51) Int. Cl. A23B 7/144

(52) U.S. Cl. CPC A23B 7/144
USPC 424/725; 426/320

(57) ABSTRACT

The present invention relates to the fungicidal, bactericidal and/or antioxidative treatment of foodstuffs, by means of formulations of essential oil in a dialkylene glycol.

The present invention relates to novel formulations for treating foodstuffs, notably fruit, as well as to the treatment method by means of said formulations by application to said foodstuffs.

It is important that said foodstuffs do not lose their organoleptic properties and retain an appealing aspect when they are placed on the market for rapid consumption. Now, after harvesting, the fruits for example are currently stored for relatively long periods before being placed on the market. The phenomena which may alter the aspect and the taste of the fruit are notably the proliferation of fungi and bacteria at their surface, as well as premature scalds due to oxidized products expressed by blackening of the skin. These deteriorations are even faster at micro-injuries and cuts appearing on the skin during the storage or the handling of the fruit.

Many methods exist in the state of the art for treating fruit, which gives the possibility of slowing down and/or totally or partly preventing proliferation of bacteria and fungi at their surface.

Thus, the application WO 00/32053 describes a method for fungicidal treatment of fruit and vegetables after harvesting by spraying or showering a composition comprising eugenol, optionally a surfactant and optionally a solvent selected from alcohols, glycols, water, carboxylic acid alkyl esters and mixtures thereof, said composition being brought to a temperature comprised between 40° and 60° C. However the treatment requires rapid cooling of the fruit and vegetables.

EP0795272 proposes an antioxidative method for fruit and vegetables by immersion or showering of an aqueous composition comprising a terpene and/or polyphenol compound, at a temperature comprised between 40° C. and 60° C. The composition advantageously comprises a surfactant.

WO00/32054 mentions a composition comprising eugenol and dipropylene glycol: however this formulation is used for antigerminating treatment of potatoes, by dispersion or putting them in solution in water, and then spraying.

However, immersion or showering at 40-60° C. may be phytotoxic and a short duration of application and/or subsequent cooling of the treated fruit is required thus making the method difficult to apply.

Immersing and showering do not allow a coating of satisfactory quality.

Finally, these methods require the presence of surfactants which in fact affect the penetration of the active ingredient into the skin of fruit, so that the active ingredient is little absorbed and evaporated. It is therefore necessary to use high concentrations and doses of active ingredient in order to take this significant loss into account. Now, this dose increase has two major drawbacks:
the level of residues which inevitably increases in the foodstuffs;
the taste and/or the unpleasant smell of eugenol which results from these residues; and
the cost in active ingredient to be applied, based on the actually efficient amount for the fruit.

Thus, it is desirable to make novel formulations available for treating foodstuffs giving the possibility of boosting the activity of the active ingredient while allowing easy application. The present inventors have therefore brought to light that the combination of an essential oil and of dialkylene glycol gave the possibility of boosting the fungicidal, bactericidal and antioxidative effect of the essential oil, thereby allowing a decrease in the amount of essential oil and of active material, and therefore limiting the residues in the treated foodstuffs.

According to a first object, the present invention therefore relates to a method for fungicidal, bactericidal and/or antioxidative treatment of foodstuffs comprising the application of a formulation comprising an essential oil and/or one of its constituents or their mixtures in a dialkylene glycol.

Typically, the formulation may be in the form of a solution. Advantageously, the formulation does not contain any water.

Generally, said formulation comprises from 10% to 80% (by weight) of essential oil and/or one of its constituents or their mixtures and 20% to 90% (by weight) of dialkylene glycol, preferentially from 10 to 70% of said constituent and from 30% to 90% of dialkylene glycol.

As foodstuffs, the present invention is notably directed to fruit and particularly the treatment of apples, pears, tomatoes, peaches, citrus fruit, persimmons, pomegranates, kiwis, grains.

The term of <<essential oil>> applied here targets the essential oil as well as one of its constituents and/or its mixtures. The term of <<constituent>> refers here to active constituents, i.e. having a bactericidal, fungicidal and/or antioxidative activity, notably a fungicidal and antioxidative activity.

Thus, as an essential oil, mention may notably be made of mint oil, and/or thymian oil and/or oregano oil and/or clove oil, as well as their constituents, i.e. L-carvone, thymol, carvacrol and eugenol respectively and/or their mixtures.

Said oils generally comprise from 50 to 90% of said constituents; thus, clove oil generally contains about 80% of eugenol and mint oil about 70% of L-carvone.

By <<dialkylene glycol>>, is meant a compound of the following formula (I):

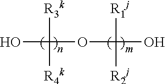

wherein:
n and m represent independently an integer from 1 to 5,
j represents an integer varying from 1 to m and k represents an integer varying from 1 to n,
for each value of j and for each value of k, R₁^{j}, R₂^{j}, R₃^{k} and R₄^{k} either identical or different, represent independently a hydrogen atom, a linear or branched hydrocarbon comprising from 1 to 10 carbon atoms, notably a branched or linear alkyl group comprising from 1 to 10 carbon atoms, preferably from 1 to 5 carbon atoms.

Preferably, for each value of j and for each value of k, R₁^{j}, R₂^{j}, R₃^{k} and R₄^{k} represent independently a hydrogen atom, a methyl, an ethyl, an n-propyl or i-propyl.

Diethylene glycol, dipropylene glycol and dibutylene glycol are examples of dialkylene glycol. According to a particular aspect, said dialkylene glycol is dipropylene glycol.

The solution may comprise a mixture of dialkylene glycols of formula (I).

The formulations notably appear in the form of a solution. By <<solution>>, is meant that the essential oil is soluble in the dialkylene glycol. Thus, upon applying the formulation according to the invention on foodstuffs, the essential oil is distributed uniformly and does not lead to the formation of clusters.

The formulations according to the invention have a fungicidal and/or antioxidative activity, comparable to the formulations concentrated in active ingredients and this at an equivalent total dose.

The formulations according to the invention also have the advantage of reducing phytotoxicity which may be observed upon applying essential oils and/or their constituents. Thus, the formulations according to the invention have less phytotoxicity than the formulations concentrated in active ingredient and this at an equivalent total dose.

Further, it has been demonstrated by the inventors that the level of residues is clearly less in the case of the formulations according to the invention from the first days after application, comparatively with the concentrated formulations of essential oils and this based on an equivalent total dose of active ingredient. This lower absorption level, notably from the application, notably gives the possibility of slowing down the degradation of the organoleptic properties and of suppressing phytotoxicity.

On the other hand, the solutions according to the invention are perfectly stable for up to several months, preferably for at least one month, at low temperature, preferably up to 0° C. This therefore allows the final user to store the formulations in cold storage rooms, for example.

According to a particular embodiment, the solution may further comprise one or several emulsifiers.

According to the present invention, by <<emulsifier>> is meant any type of agent customarily used for this purpose, such as ethoxylated fatty alcohols, ethoxylated fatty acids, ethoxylated alkylphenols or any other non-ionic product.

The formulations according to the invention may generally comprise from 0% to 20% by weight, notably from 0% to 15% by weight and more particularly from 1 to 5% by weight of emulsifier.

The method according to the invention is preferably applied for fungicidal and antioxidative treatment and more particularly fungicidal treatment.

The application is generally achieved by thermal fogging.

The latter may advantageously be achieved by means of the Electrofog Xeda apparatus or any other device as described in the application FR 2 566 681. As the boiling temperature of said alkylene glycols is high and that of the oils greater than 230° C., it is possible to achieve thermal fogging at high temperatures and to obtain fogs of good quality. For example, the boiling temperature of dipropylene glycol is 232° C. The thermal fogging temperature is generally 40 degrees below that of the boiling temperature, and is therefore close in this case to 192° C. At this temperature, a good quality fog is obtained, i.e. consisting of particles of small size and of low distribution, which gives the possibility of distributing the essential oil and/or its constituents over the foodstuffs in a very homogeneous way.

Preferably, the formulations according to the invention are applied at a temperature comprising between 170° and 230° C., notably between 190° and 215° C., in the case of thermal fogging. In the case of atomization, the formulations may be applied at a temperature comprised between 0° and 35° C., notably in cold storage rooms.

The amount of formulation according to the invention which has to be applied to the foodstuffs essentially depends on the selected application method. Generally, about 30 to 300 g, generally from 100 to 200 g of formulation per metric ton of treated foodstuffs, i.e. from 3 to 210 g/ton, generally from 10 to 140 g/ton of active ingredient, particularly about 75g/ton of active ingredient are applied over a period of 6 months by application.

The application may be continuous or intermittent during the storage period. Preferably, the application is repeated in the storage enclosure every month at doses reduced relatively to the first application. The advantage of this repeated application is to periodically also purify the atmosphere of the room by lowering the level of spores in the air and to lower the risk of indirect contamination of sound foodstuffs by the spores of fungi conveyed by the recirculation of a polluted atmosphere.

Thus, for example, the application is repeated every month, with a dose per application, comprised between 15 and 100 g, preferably 50 g of formulation per metric ton of treated foodstuffs.

According to another object, the invention also relates to a method for preparing formulations according to the invention comprising the step consisting of solubilizing an essential oil and/or its constituents in a dialkylene glycol. Preferably, the dialkylene glycol is dipropylene glycol. The solubilization may generally be carried out with stirring.

The bacterial strains affecting foodstuffs are for example Erwinia carotovora or Escherichia coli. As examples of fungi species, mention may be made of Fusarium oxysporum, Geotricum candidum, Gloeosporium fructigenum, Penicillium digitatum, Penicillium expansum, Phytophthora parasitica, Botrytis cinerea, Monilinia fructigena, Aspergillus niger

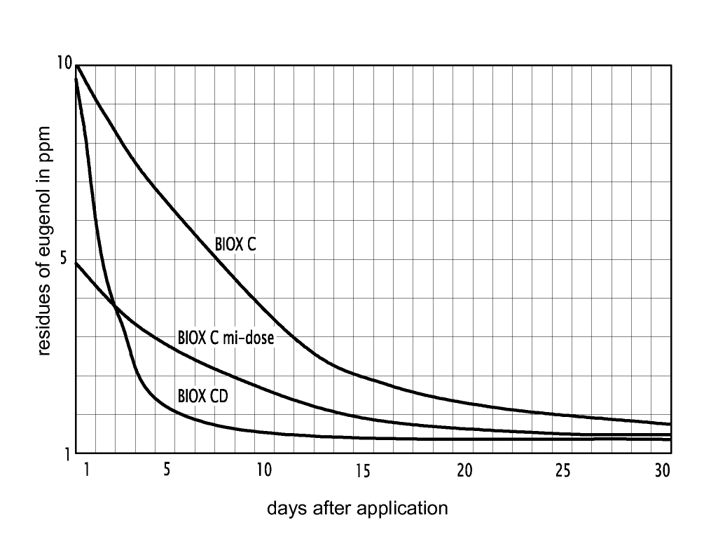

FIG. 1 represents the levels of eugenol residues in fruit treated with a formulation according to the invention (BIOX CD) and as a comparison, a concentrated formulation with a close equivalent total dose (BIOX C) and a concentrated formulation at a total half-dose (BIOX C half-dose).

### The following examples are given as an illustration and not as a limitation to the present invention.

### EXAMPLE 1

### Determination of the Efficiency of Clove Oil (Biox C) and of Clove Oil Dissolved in Dipropylene Glycol (Biox CD) Against Post-Harvest Diseases of Apples and Pears

This study was conducted in order to evaluate the fungicidal efficiency of the Biox C formulation (containing about 80% of eugenol) and of the Biox CD formulation (25% of clove oil in 75% of dipropylene glycol, i.e. comprising abut 20% of eugenol), each of the formulations being applied by thermal fogging with Electrofog Xeda®, at a temperature of about 192° C., and at a concentration of 25 g per ton for the formulation Biox C (i.e. 20 g/ton of eugenol) and 80 g per ton for the formulation Biox CD (i.e. 16 g/ton) on apples and pears. Quasi-equivalent total eugenol doses were therefore applied.

The phytotoxicity of the treatments was also studied for the treated fruit.

Golden apples and Abate pears were harvested and then placed in cold storage rooms at 1° C. The fruit were then inoculated at room temperature. The skin of the fruit was cut on its equator over a thickness of 1 mm and a suspension of pathogenic spores was inoculated. The fruit were dried for 24 hours and then again placed in a cold storage room for treatment by atomization.

Three pathogenic strains were inoculated: Botrytis cinerea, Penicillium expansum and Monilinia fructigena. Each inoculated batch was respectively treated with the Biox C formulation and the Biox CD formulation (at 25 g and 80 g of formulation per ton of fruit respectively). An untreated batch was used as a control.

The results were the following:

Fungicidal activity: All the treated batches gave the possibility of statistically monitoring the disease, both in terms of incidence and of severity.

Phytotoxicity: certain phytotoxicity symptoms were observed with the Biox C formulation. No phytotoxicity was observed with the Biox CD formulation, and this in spite of the equivalent total eugenol dose.

Organoleptic evaluation of the treated fruit: a significant alteration of the taste was detected for apples and pears treated with the Biox C formulation. No change in taste was detected with the Biox CD formulation and this in spite of the equivalent total eugenol dose.

Determination of the levels of eugenol residues: the goal of this study was to determine the levels of eugenol residues in apples and pears after applying the Biox C and Biox CD formulations. The results are summarized in the following table:

| | Eugenol residues | | |
|---|---|---|---|
| | BIOX C | BIOX CD | |
| Test duration | [mg/kg] | [mg/kg] | UNTR. |
| 7 days after treatment | | | |
| Apples | 5.18 | 0.91 | 0.2 |
| Pears | 11.7 | 2.97 | 0.07 |
| 30 days after treatment | | | |
| Apples | 0.91 | 0.39 | — |
| Pears | 1.24 | 0.52 | 0.06 |

The levels of residues after treatment with the Biox C formulation at 7 days on apples were six times higher than with the treatment with the Biox CD formulation, and four times higher on pears.

At 30 days after treatment, the levels of eugenol residues with the Biox C formulation on apples and pears were 2.4 times higher than the levels of residues obtained with the Biox CD formulation.

FIG. 1 illustrates the variation curves of eugenol residues over time with the formulations according to the invention (Biox CD) and the concentrated eugenol formulations (Biox C). A sudden drop in residues appears in FIG. 1, obtained with the Biox CD formulation from the first days after treatment. This very low level of residues thus reduces the too significant absorption risk by the fruit in the initial phase, which gives the possibility of limiting the consequent risks of phytotoxicity and of bad taste.

With the Biox CD formulation, the value of residues is from the 20^{th} day, about half as compared with the Biox C formulation. This value guarantees the presence of an acceptable residue and protection of the fruit for about 30 days.

It also appears from FIG. 1 that with the Biox C formulation used at a half-dose it is possible to obtain a same residue as with the Biox CD formulation at 30 days but with much more significant values of residues during the first days. These high values lead to significant absorption by the skin of the fruit, with detrimental impacts in terms of taste and phytotoxicity.

1. A method for fungicidal bactericidal and/or antioxidative treatment of foodstuffs comprising the application of a formulation of essential oil and/or one of its constituents or their mixtures in a dialkylene glycol.

2. The method according to claim 1, such that said formulation is in the form of a solution.

3. The method according to claim 1, such that the formulation comprises from 10% to 80% (by weight) of essential oil and/or one of its constituents or their mixtures and from 20% to 90% (by weight) of the dialkylene glycol.

4. The method according to claim 1, such that the formulation comprises from 10% to 70% (by weight) of said constituent and 30% to 90% (by weight) of the dialkylene glycol.

5. The method according to claim 1, such that the essential oil is selected from mint oil, thymian oil, oregano oil and clove oil.

6. The method according to claim 1, such that said constituent is selected from L-carvone, thymol, carvacrol and eugenol.

7. The method according to claim 1, such that said constituent is eugenol.

8. The method according to claim 1, such that the dialkylene glycol is selected from diethylene glycol, dipropylene glycol and dibutylene glycol.

9. The method according to claim 1, such that said dialkylene glycol is dipropylene glycol.

10. The method according to claim 1, such that the formulation is applied by thermal fogging.

11. The method according to claim 1, such that at each application between 30 and 300 g of formulation per ton of treated foodstuffs are applied.

12. The method according to claim 1, such that the application is repeated every month, with a dose per application, comprised between 15 and 100 g, preferably 50 g of formulation per ton of treated foodstuffs.
